(19) United States
(12) Patent Application Publication
(10) Pub. No.: US 2005/0050944 A1
(43) Pub. Date: Mar. 10, 2005

(54) Sensor and method for manufacturing the same

(76) Inventors: Seung Chul Ha, Suwon-Shi (KR); Yong Shin Kim, Daejon-Shi (KR); Yoon Seok Yang, Seongnam-Shi (KR); Young Jun Kim, Daejon-Shi (KR); Hae Sik Yang, Daejon-Shi (KR); Yun Tae Kim, Daejon-Shi (KR)

Correspondence Address: JACOBSON HOLMAN PLLC, 400 SEVENTH STREET N.W., SUITE 600, WASHINGTON, DC, 20004, US

(21) Appl. No.: 10/788,441

(22) Filed: Mar. 1, 2004

(30) Foreign Application Priority Data
Sep. 6, 2003 (KR) 2003-62413

(51) Int. Cl. G01N 11/00

(52) U.S. Cl. 73/53.01; 73/31.06

(57) ABSTRACT

Provided is a sensor including a semiconductor substrate having a well of a membrane, a sensor, a heater, and an electrode, and a method for manufacturing the same, whereby it is possible to realize the sensor, which is a small size, stable, and mass produced.

### BACKGROUND

1. Field of the Invention

The present invention relates to a sensor and a method for manufacturing the same and, more particularly, to a sensor having a well and a method for manufacturing the same.

2. Discussion of Related Art

In many fields, it has been required to monitor and sense various kinds of chemical gases. For example, it is particularly required in the field of sensing a leakage of a noxious gas in an environmental monitoring, controlling processes for manufacturing foods or perfumes in industrial uses, and keeping qualities thereof. In addition, it has been tried to broaden the application range into a field where a disease is checked by sensing a respiration of a human body.

Meanwhile, research and development of the sensor have been made more actively with an introduction of a concept of electronic nose by Gardner. The concept of the electronic nose introduced by Gardner is disclosed in Electronic Noses, entitled “Principles and Applications”, Oxford University Press Inc., New York, N.Y. 1999, 3, written by Gardner, J. W. and Bartlett, P. N.

Sensors can be divided according to sensor materials being used. In other words, the sensors can be divided into a gas chromatograph which is developed at first, a mass spectrometer, a metal oxide gas sensor, a surface acoustic wave gas sensor, a gas sensor of a mixture of an insulator and a conductor, and so on. In general, the gas sensor of a mixture of an insulator and a conductor is formed by melting a mixture of an insulator and a conductor in a solvent, dropping it on an electrode, and then evaporating the solvent. The electronic nose should be formed by combining various sensors which react in many kinds of reactions, since the electronic nose is aimed at making various sensors into arrays and having a pattern that each sensor reacts. Considering this, the gas sensor of a mixture of an insulator and a conductor is applicable as the electronic nose.

Hereinafter, sensors of a prior art will be explained with reference to FIGS. 1 and 2.

FIG. 1 is a picture of a sensor array in accordance with a prior art, in which an electrode 120 is formed on a ceramic substrate 110 and a sensor material 130 of a mixture of an insulator and a conductor melted in a solvent is dropped thereon. The sensor shown in FIG. 1 has been disclosed in “M. L. Homer, M. G. Buehler, K. S. Manatt, F. Zee, J. Graf: Monitoring the air quality in a closed chamber using an electronic nose, in Proceedings of the 27^{th} International Conference on Environmental systems, 14-17, July, 1997”. In the case of using the technique of FIG. 1, the sensor material 130 is dropped on the substrate 110 in the state being melted in the solvent, so that widely spreads thereon. Thus, according to the technique, a thickness that influences on a level of a reaction cannot be controlled. Furthermore, the sensor material cannot be controlled since the sensor material spreads widely, so that a sensor array cannot be integrated to a small size.

FIG. 2 is a picture of a sensor in accordance with a prior art, in which an electrode 240 is formed on a substrate 210, a well 240 is formed by using an SU-8 photoresist 230, and a sensor material is dropped inside the well 240. The sensor shown in FIG. 2 has been disclosed in “Frank Zee, Jack W. Judy: Micromachined polymer-based chemical gas sensor array, sensors and actuator B 72,120-128, 2001”. According to the technique of FIG. 2, there is a merit that the sensor material of a mixture of an insulator and a conductor does not spread on the electrode 220, when the sensor material is dropped thereon. However, there are some problems that the SU-8 photoresist 230 is not resistant to the solvent, so that it may be melted in the solvent, and the property thereof can be variable depending on a temperature variation.

In case where a mixture of an insulator and a conductor is used as the sensor material, a polymer is widely used as the insulator. However, the polymer has such a problem that characteristics thereof are very sensitive to temperature. Thus, the temperature of the sensor material has to be kept when the mixture of the insulator and the conductor is used as the sensor material. However, in the case of sensors in accordance with a prior art, the temperature thereof cannot be kept or, if any, it is not applicable for portable uses since large scale of electric powers are required for keeping the temperature of the thick substrate.

### SUMMARY OF THE INVENTION

The present invention is contrived to solve the aforementioned problems and directed to a sensor and a method for manufacturing the same. According to a preferred embodiment of the present invention, there are provided a sensor that is resistant to a solvent and a property thereof is not variable depending on the temperature variation and a method for manufacturing the same. In addition, it is possible to keep a temperature of a sensor material with a lower electronic power.

One aspect of the present invention is to provide a sensor, comprising: a semiconductor substrate having a well of a membrane, wherein a sidewall of the well is insulated and a bottom of the well includes an insulation film; a sensor material being placed inside the well and having a variable electrical characteristic depending on a physics quantity to be sensed; a heater being placed in the membrane and keeping a temperature of the sensor material constant; and an electrode contacting with the sensor material and measuring an electrical characteristic of the sensor material.

Here, the sensor further comprises an insulation film between the semiconductor substrate and the electrode. The membrane is a double film of a silicon oxide and a silicon nitride. The physics quantity is a liquid component, a light, or a gas and the sensor material is a mixture of an insulator and a conductor.

Another aspect of the present invention is to provide a method for manufacturing a sensor, comprising the steps of: forming an electrode on one side of a semiconductor substrate; forming an insulation film corresponding to a membrane on one side of the semiconductor substrate; forming a heater on one side of the semiconductor substrate; removing a part corresponding to a well from the other side of the semiconductor substrate to expose the electrode; and placing a sensor material inside the well.

Here, a step of forming an insulation film can be further included before the step of forming the electrode, and a step of forming a protection film for protecting the heater can be further included after the step of forming the heater.

In a preferred embodiment of the present invention, the step of removing a part corresponding to a well comprises the steps of: forming a bulk etching mask in the other side of the semiconductor substrate; removing a part corresponding to a well from the other side of the semiconductor substrate to expose the electrode; and insulating a part corresponding to the sidewall of the well. The step of forming the membrane includes a step of depositing a silicon nitride and a silicon oxide.

### BRIEF DESCRIPTION OF THE DRAWINGS

The aforementioned aspects and other features of the present invention will be explained in the following descriptions taken in conjunction with the accompanying drawings, wherein:

FIGS. 1 and 2 are pictures of a sensor array and a sensor manufactured by a prior art.

FIG. 3 is a schematic sectional view in accordance with a preferred embodiment of the present invention.

FIG. 4 is a schematic sectional view and FIG. 5 is a schematic elevation in case where an array is composed by a sensor in accordance with a preferred embodiment of the present invention.

FIGS. 6 to 15 are sectional views of processes for manufacturing a sensor sequentially.

FIG. 16 is a picture of one aspect of a substrate after an array of a sensor is manufactured on a silicon substrate.

FIG. 17 is a picture of another aspect of a substrate after an array of a sensor is manufactured on a silicon substrate.

FIG. 18 is a picture of a sensor array chip obtained by cutting an array of a sensor manufactured on a silicon substrate.

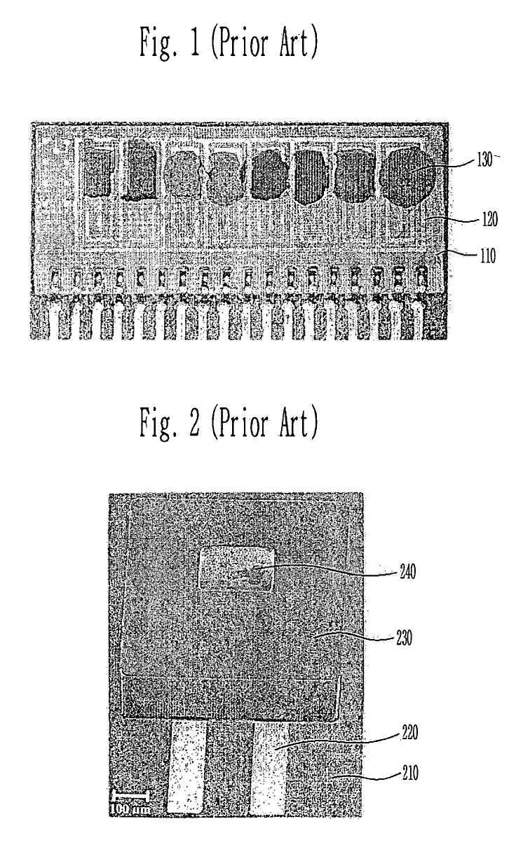

### DETAILED DESCRIPTION OF PREFERRED EMBODIMENTS

Now the preferred embodiments according to the present invention will be described with reference to accompanying drawings. Since preferred embodiments are provided for the purpose that the ordinary skilled in the art are able to understand the present invention, they may be modified in various manners and the scope of the present invention is not limited by the preferred embodiments described later.

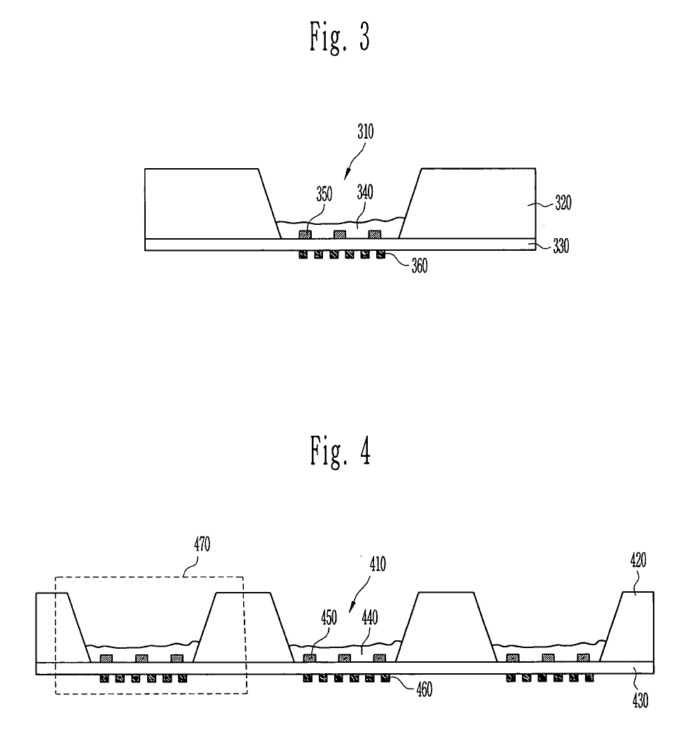

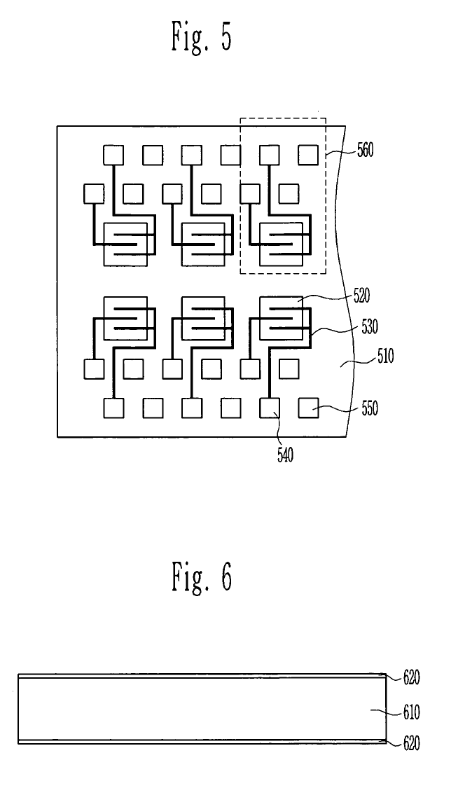

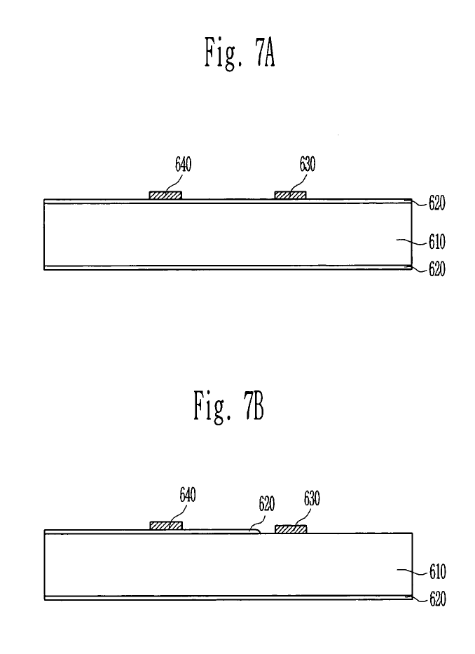

FIG. 3 is a schematic sectional view in accordance with a preferred embodiment of the present invention. A side wall of a sensor is insulated and a bottom of the sensor includes a semiconductor substrate 320 in which a well 310 of a membrane 330 is formed, a sensor material 340 being placed inside the well, an electrode 350 for measuring a variation of characteristic in the sensor material 340, and a heater 360 for keeping a temperature of the sensor material 340 constant.

In the semiconductor substrate 320 including the well 310, the sidewall of the well 310 is insulated and the bottom of the well 310 is the membrane 330 having an insulation film. By forming the well using the semiconductor substrate 320 as described above, the present invention can provide the well that is resistant to a solvent and the property thereof is invariable to a variation of a temperature comparing to a well implemented using an SU-8 photoresist of a prior art.

Meanwhile, it is preferable that the membrane 330 includes the insulation film and the sidewall of the semiconductor substrate is insulated so that a current flowed into the sensor material via the electrode 350 does not flow to the membrane 330 and the semiconductor substrate 320, since the side walls of the membrane 330 and the semiconductor substrate contact with the sensor material 340. In addition, the membrane is preferably composed of a double film of a silicon nitride and a silicon oxide films. The reason is that the membrane composed of the double film as described above is more stable than a membrane composed by only a silicon oxide film or a silicon nitride film, because the membrane of the double film offsets stresses of the silicon nitride film and the silicon oxide film.

The sensor material 340 refers to such a material that the electrical characteristics thereof are variable according to a physics quantity to be sensed. For example, the sensor material 340 can be a mixture of an insulator and a conductor. In this case, there is a problem that the sensor is affected by a temperature since most of insulators are polymers that the characteristics thereof vary considerably with a temperature. Thus, it is necessary to keep the temperature of the sensor material constant by using the heater 360.

The electrode 350 is used for measuring a variation of an electrical characteristic of the sensor material 340 by contacting with the sensor material 340. A portion of the electrode can be placed on the semiconductor substrate like a pad (not shown) of the electrode. At this time, an insulation film (not shown) is further included between the electrode 350 and the semiconductor substrate 320.

The heater 360 is used to keep the temperature of the sensor material constant so that the sensor is not affected by the outer temperature. According to the present invention, it is possible to transfer heat readily to the sensor material 340 by placing the heater 360 to the membrane 330, and to keep the temperature of the sensor material 340 constant with a lower electric power since it is not necessary to heat the whole substrate at the same time.

For example, the electrode 350 or the heater 360 can be gold (Au), white gold (Pt), aluminum (Al), molybdenum (Mo), silver (Ag), TiN, tungsten (W), ruthenium (Ru), iridium (Ir), or silicon (Si), etc. In addition, the electrode 350 or the heater 360 can be implemented as a double layer by using a metal material and a material that increases an adhesion of a metal material such as chrome (Cr) or titanium (Ti).

The sensor described in FIG. 3 has an electrical characteristic that varies according to a physics quantity to be sensed, and functions to sense a physics quantity, for example a kind of a gas, by operating in a manner that a changed electrical characteristic is measured via the electrode 350. The heater 360 serves as protecting an electrical characteristic of the sensor material from changing according to an ambient temperature by keeping the temperature of the sensor material 340 constant. At this time, by placing the heater to the membrane 330, the sensor material is heated by heating only a thin membrane different from a prior art, in which a sensor material is heated by heating a thick semiconductor substrate. As a result, a heat loss due to heat conduction is prohibited and a sensor of a lower electric power can be implemented.

FIG. 4 is a schematic sectional view and FIG. 5 is a schematic elevation in case where an array is composed by a sensor in accordance with a preferred embodiment of the present invention.

Referring to FIG. 4, an array of the sensor is composed of several unit sensors 470. Each unit sensor comprises a sensor material 440, an electrode 450, a heater 460, and a semiconductor substrate 420 in which a well 410 having a membrane 430 is formed like the sensor shown in FIG. 3.

FIG. 5 is an elevation of an array of the sensor shown in FIG. 4. Reference number 560 indicates a sensor, 510 is a membrane, 520 is a membrane located in a place where there is the well, 530 is an electrode, 540 is a pad of the electrode, and 550 is a pad of a heater.

Arrays of the sensors shown in FIGS. 4 and 5 have an advantage that many kinds of physics quantities such as various kinds of gases can be measured at the same time by varying the sensor material in each unit sensor.

FIGS. 6 to 15 are sectional views of processes for manufacturing a sensor sequentially.

Referring to FIG. 6, an insulation film 620 is formed on a substrate 610. Preferably, the substrate 610 is a semiconductor substrate of which both sides are polished. For example, the semiconductor substrate 610 is a silicon substrate or a gallium-arsenic (GaAs) substrate. In the case of the semiconductor substrate 610, if an electrode is formed just on the substrate 610, a current comes to flow via the substrate 610. Thus, it needs to form an insulation film 620 to prevent the aforementioned problem. The insulation film is preferably formed by means of a growing method for an oxide film. For example, the oxide film can be formed with a thickness of 100 nm.

Referring to 7A, a metal material is deposited on the insulation film 620 located in one side of the substrate 610, and then an electrode 630 and a pad 640 of the electrode are formed by patterning the metal material. The electrode 630 and the pad 640 of the electrode are electrically connected. As the metal material, for example, gold (Au), white gold (Pt), aluminum (Al), molybdenum (Mo), silver (Ag), TiN, tungsten (W), ruthenium (Ru), iridium (Ir), or silicon (Si), etc. can be used. Before depositing the metal material, a material that increases an adhesion between the insulation film 620 and the metal material can be deposited. The material that increases an adhesion is chrome (Cr) or titanium (Ti) and a thickness thereof is 5 nm. The thickness of the metal material can be 100 nm. The patterning process can be performed by using an etching process of a lift-off process. The electrode 630 is used for sensing a variation of the electrical characteristic in the sensor material to be formed in the subsequent process.

Meanwhile, process steps explained with reference to FIG. 7A could be continued selectively. Referring to 7B, a part where the membrane will be formed in the subsequent process of the insulation film 620 located one side of the substrate 610 is removed, a metal material is deposited, and the electrode 630 and the pad 640 of the electrode are formed by patterning the metal material. The electrode 630 and the pad 640 of the electrode are electrically connected. The insulation film could be removed by using a wet etching or a dry etching method. By means of a process shown in FIG. 7A, a removing process of the insulation film is further performed after performing the subsequent bulk etching process, to expose the electrode. However, in the case of 7B, the removing process of the insulation film can be omitted since the electrode is exposed by performing the subsequent bulk etching.

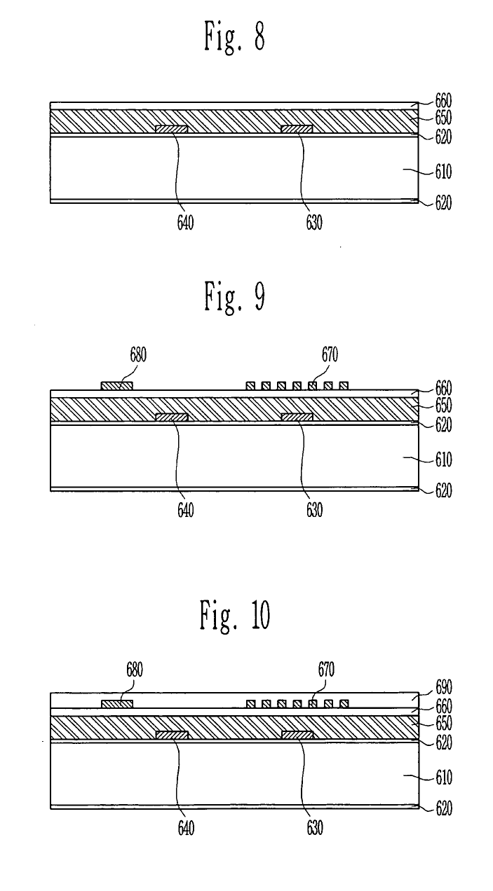

Referring to FIG. 8, the insulation film is deposited on one side of the substrate 610. It is preferable that a stress between the silicon nitride 650 and the silicon oxide 660 is set off each other by depositing the silicon nitride and the silicon oxide with the insulation film. The silicon nitride 650 and the silicon oxide 660 can be formed with a thickness of 1.5 μm and 300 μm, respectively.

Referring to FIG. 9, a metal material is deposited on the silicon oxide film 660 that is located on one side of the substrate 610, and a heater 670 and a pad 680 of the heater are formed by patterning the metal material. The heater 670 and the pad 680 of the heater are electrically connected. As the metal material, for example, gold (Au), white gold (Pt), aluminum (Al), molybdenum (Mo), silver (Ag), TiN, tungsten (W), ruthenium (Ru), iridium (Ir), or silicon (Si), etc. can be used. Before depositing the metal material, a material that increases an adhesion between the silicon oxide film 660 and the metal material can be deposited. The material that increases an adhesion is chrome (Cr) or titanium (Ti) and a thickness thereof is 5 nm. The thickness of the metal material can be 100 nm. The patterning process can be performed by using an etching process of a lift-off process.

Referring to FIG. 10, a passivation layer 690 is formed to protect the heater 670 from the physical attack of the outside. For example, the passivation layer 690 could be a silicon oxide film with a thickness in the range of 100 nm to 300 nm.

Referring to FIG. 11, a material 700 to be used as an etch mask of a bulk etching is deposited on the other side of the substrate 610. Preferably, the material 700 is a silicon oxide film or a silicon nitride film, which is hardly etched when an anisotropic wet etching, a kind of a bulk etching. The silicon oxide film or the silicon nitride film can be formed with a thickness of approximately 500 nm.

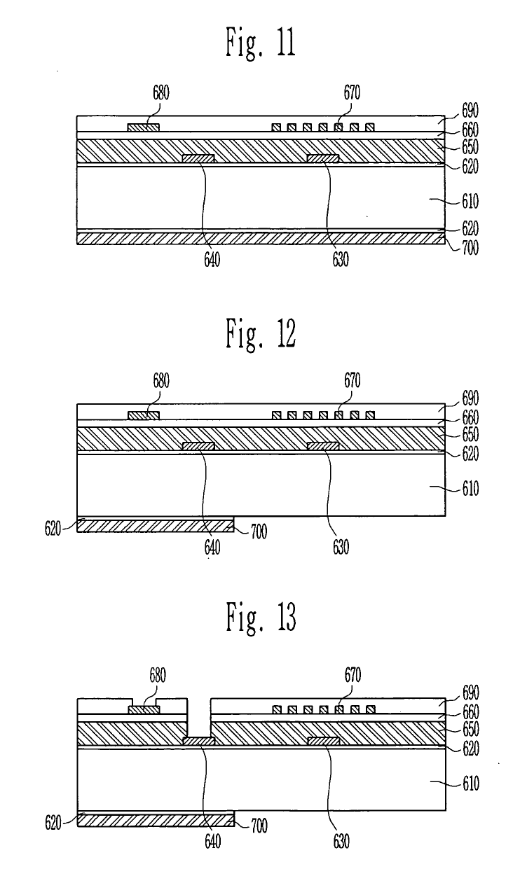

Referring to FIG. 12, a part, in which a well will be formed, of the material 700 to be used as an etch mask and the insulation film 620 is removed by using a wet etching method or a dry etching method.

Referring to FIG. 13, the pad 640 of the electrode and the pad 680 of the heater are opened by means of the dry etching method to be electrically connected with the electrode 630 and the heater 670, respectively.

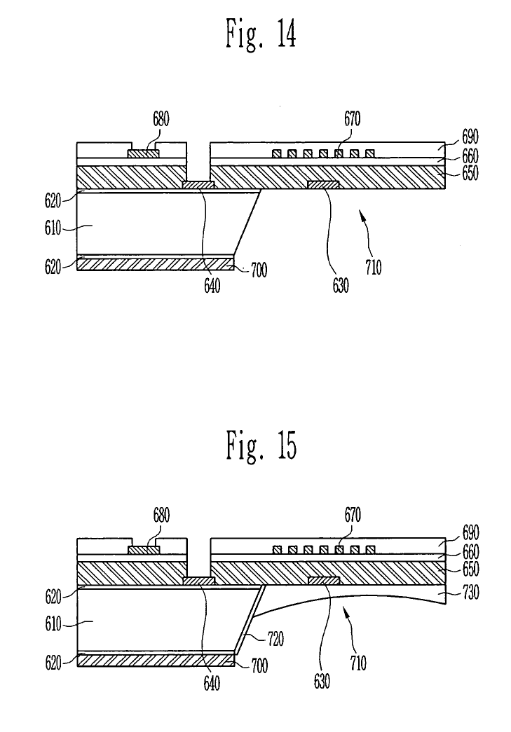

Referring to FIG. 14, a well 710 is formed by removing the substrate corresponding to the well by means of a bulk etching of the substrate 610. In the case of using a silicon substrate, the silicon substrate could be wet etched anisotropically by using a KOH or a tri-methyl ammonium hydroxide (TMAH) as an etching solution. The resultant well 710 functions to protect the sensor material, which is dropped on the electrode in the subsequent process, from spreading, and makes the sensor material having a predetermined thickness reproducible. In addition, since the part corresponding to the well 710 is completely removed and the heat loss in the heater 670 can be reduced when the heater 670 applies heat to the sensor material, the heater 670 could be operated with a lower electrical power. In the case of performing the processes with reference to FIG. 7A of the selected processes explained in accordance with FIGS. 7A and 7B, the insulation film placed in the membrane of the insulation film 620 should be further removed after performing the process of removing the substrate corresponding to the well 710 of the substrate 610. On the contrary, In the case of performing the processes with reference to FIG. 7B, the process of removing the substrate corresponding to the well 710 of the substrate 610 is only performed.

Referring to FIG. 15, a sensor material 730 is formed on the electrode 630 after forming an insulator 720 that insulates the sidewall of the well. In the case of using a semiconductor substrate as a substrate 610, it is necessary to form the insulator 720 to prevent that the current flows from the sensor material 730 to the sidewall of the well 710. Preferably, the insulator 720 is formed by using a hard mask process. In the hard mask process, the insulator is selectively deposited only to the sidewall of the well 710, by contacting the hard mask having a hole in the part where is corresponding to the sidewall of the well 710 with the other side of the substrate and then depositing the insulator thereto. For example, the sensor material 730 is a sensor material of a mixture of an insulator and a conductor.

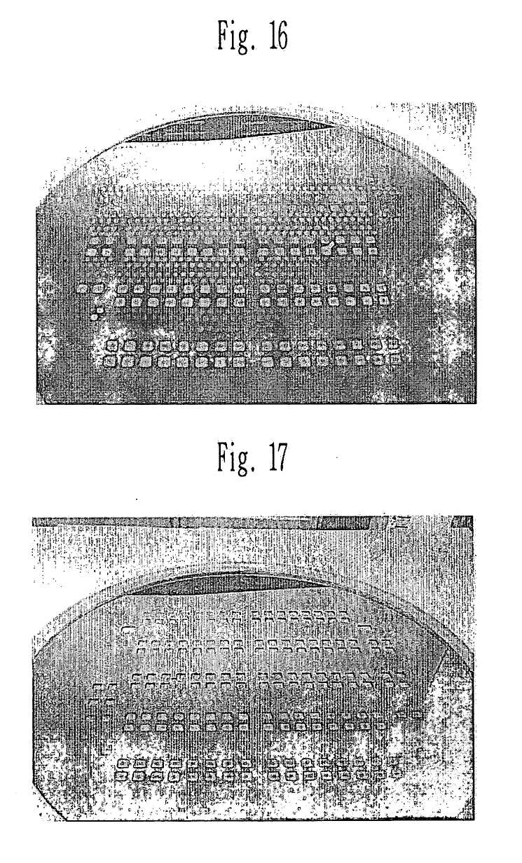

FIGS. 16 and 17 are pictures of one and another aspects of an array of a sensor manufactured by an embodiment, respectively. According to the sensor array shown in drawings, the mass production comes to be possible and the production cost can be lowered since the thin film process and the micro machining process are performed with a wafer process.

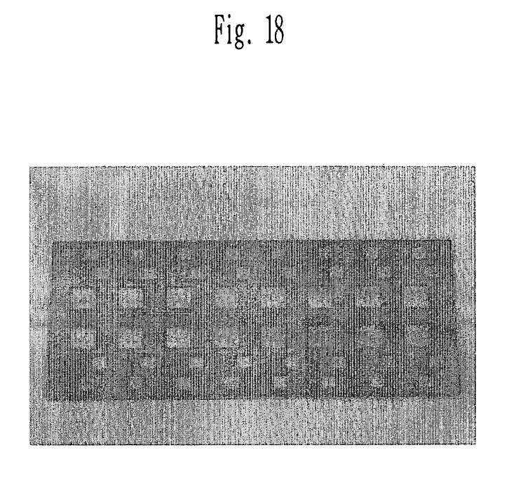

FIG. 18 is a picture of a chip of a sensor array manufactured by an embodiment. The chip shown in the drawing has a size of 32 mm×16 mm, so that it can be a small size and operated by a portable battery.

As described above, according to the present invention, it is possible to realize the sensor, which is a small size, stable, and mass produced, by forming a well using a semiconductor substrate instead of an SU-8 photoresist of which characteristics are variable according to the temperature and not resistant to the solvent.

In addition, the temperature of the sensor material can be kept constant with a lower electrical power by placing the heater to the membrane, and the production cost can be reduced since the sensor can be mass-produced with a wafer process.

While the present invention has been described with reference to the illustrative embodiments, various modifications of the illustrative embodiments will be apparent to those skilled in the art on reference to this description. It is therefore contemplated that the appended claims will cover any such modifications or embodiments as fall within the true scope of the invention.

1. A sensor, comprising:
a semiconductor substrate having a well of a membrane, wherein a sidewall of the well is insulated and a bottom of the well includes an insulation film;
a sensor material being placed inside the well and having a variable electrical characteristic according to a physics quantity to be sensed;
a heater being placed in the membrane and keeping a temperature of the sensor material constant; and
an electrode being contacted with the sensor material and measuring an electrical characteristic of the sensor material.

2. The sensor of claim 1, wherein the membrane is a double film of a silicon oxide and a silicon nitride.

3. The sensor of claim 1, wherein the physics quantity is a liquid component, a light, or a gas.

4. The sensor of claim 1, wherein the sensor material is a mixture of an insulator and a conductor.

5. The sensor of claim 1, further comprising an insulation film between the semiconductor substrate and the electrode.

6. The sensor of claim 5, wherein the membrane is a double film of a silicon oxide and a silicon nitride.

7. The sensor of claim 5, wherein the physics quantity is a liquid component, a light, or a gas.

8. The sensor of claim 5, wherein the sensor material is a mixture of an insulator and a conductor.

9. A method for manufacturing a sensor, comprising the steps of:
forming an electrode on one side of a semiconductor substrate;
forming an insulation film corresponding to a membrane on one side of the semiconductor substrate;
forming a heater on one side of the semiconductor substrate;
removing a part corresponding to a well from the other side of the semiconductor substrate to expose the electrode; and
placing a sensor material inside the well.

10. The method for manufacturing a sensor of claim 9, further comprising a step of forming an insulation film before the step of forming the electrode.

11. The method for manufacturing a sensor of claim 9, further comprising a step of forming a protection film for protecting the heater after the step of forming the heater.

12. The method for manufacturing a sensor of claim 9, wherein the step of removing a part corresponding to a well comprises the steps of:
forming a bulk etching mask in the other side of the semiconductor substrate;
removing a part corresponding to a well from the other side of the semiconductor substrate to expose the electrode; and
insulating a part corresponding to the sidewall of the well.

13. The method for manufacturing a sensor of claim 9, wherein the step of forming the membrane includes a step of depositing a silicon nitride and a silicon oxide.
